(19) United States
(12) Patent Application Publication
(10) Pub. No.: US 2025/0204578 A1
(43) Pub. Date: Jun. 26, 2025

(54) AEROSOL-GENERATING ARTICLE WITH ALTERABLE IDENTIFIER

(71) Applicant: PHILIP MORRIS PRODUCTS S.A., Neuchatel (CH)

(72) Inventors: Rui Nuno Rodrigues Alves Batista, Morges (CH); Bruno Chamielec, Chez-le-Bart (CH); Balamurugan L, Tiruvallur (IN); Rodrigo Lorca, Aclens (CH); Lilian Maus Lorca, Aclens (CH); Alain Sager, Bossonnens (CH); Alexandra Sereda, Neuchatel (CH)

(21) Appl. No.: 18/709,628

(22) PCT Filed: Nov. 18, 2022
(86) PCT No.: PCT/EP2022/082440

§ 371 Date: May 13, 2024

(30) Foreign Application Priority Data
Nov. 18, 2021 (EP) 21209093.0

(51) Int. Cl. A24D 1/02; A24C 5/01; A24C 5/60; A24D 1/20; A24F 40/20; A24F 40/46; A24F 40/53

(52) U.S. Cl. CPC A24D 1/025; A24C 5/01; A24C 5/601; A24D 1/20; A24F 40/20; A24F 40/46; A24F 40/53

(57) ABSTRACT

The present invention relates to an aerosol-generating article, adapted to be electrically heated by an aerosol-generating device. The aerosol-generating article comprises an aerosol-generating substrate, an optical information storage element storing information in a grid pattern with a plurality of segments comprising at least one alterable segment. The at least one alterable segment comprises a first layer and a second layer, wherein at least one optical property of at least one layer is adapted to be altered. The invention further relates to a method for manufacturing an information storage element, an aerosol-generating system comprising an aerosol-generating article and an aerosol-generating device and the use of a multi-layered information storage element on an aerosol-generating article to provide alterable supplemental information about the aerosol-generating article.

The present invention relates to an aerosol-generating article. The present invention also relates to a method for manufacturing an information storage element, an aerosol-generating system comprising an aerosol-generating article and an aerosol-generating device, and a use of a multi-layered information storage element on an aerosol-generating article.

WO 2019/129378A1 discloses a consumable for an inhaler, the inhaler comprising a heating system and an optical reader. The consumable comprises an indicia containing information about the consumable. The indicia may disappear when exposed to a temperature above a temperature threshold. The indicia may comprise a first and a second indicia, wherein the second indicia may be superposing the first indicia to distort the information on the first indicia and to make it unreadable, or may appear next to the first indicia when exposed to a temperature above a temperature threshold.

According to a first aspect of the invention, there is provided an aerosol-generating article, adapted to be electrically heated by an aerosol-generating device. The aerosol-generating article comprises an aerosol-generating substrate and an optical information storage element storing information in a grid pattern with a plurality of segments comprising at least one alterable segment. The at least one alterable segment comprises a first layer and a second layer, wherein at least one optical property of at least one of the first layer or second layer is adapted to be altered. The information stored in the optical information storage element may be changed by altering an optical property of at least one segment. An alterable information may for example indicate, whether the aerosol-generating article is unused or has already been used. By altering a segment, the altered information may remain readable and decodable based on the original information storing and encoding principle. For example, the optical information storage element may be a one dimensional barcode or two dimensional matrix code. The change of information content may be effected by changing the color or transparency or both of one or several segments. For example, a transparent or white segment may be altered to an opaque or black segment. Further, the optical information storage element may be adapted to store permanent information content, which remains unaltered during the intended use of the aerosol-generating article, that is the information content remains unaltered under a temperature condition, which is effected in the optical information storage element when heating the aerosol-generating substrate. For example, permanent information content may be data on manufacturing time, origin, best before date or product type. In particular, the optical information storage element may be adapted to store both alterable and non-alterable information, based on alterable and non-alterable segments.

The segments may be rectangular segments. This may improve their readability by means of a detector. In particular, the segments may be quadratic. In other embodiments, the segments may be oval or circular. All segments may have the same type of shape, in particular rectangular, quadratic, oval or circular.

The segments may be discrete segments. In particular, the segments may be non-overlapping.

The optical information storage element may be adapted to be altered from a first state to a second state, wherein at least one optical property of the at least one alterable segment differs in between the first state and the second state. The first state and the second state may correspond to a change in a specific information, for example to indicate that the aerosol-generating article has been used, either as Boolean information, namely used or not used, or as or with additional information regarding the use, for example one or several of length, time or temperature regarding the use.

The change of the optical property may be induced by exposing the optical information storage element to a physical condition effected by the aerosol-generating device. For example exposure to an electromagnetic radiation, in particular having a wavelength or intensity or both being different from ambient conditions may induce a change of the optical property. Further, a temperature above a threshold temperature, which is higher than ambient temperature, in particular a temperature above 60 degrees Celsius, or a temperature which is effected in the optical information storage element when heating the aerosol-generating substrate may induce a change of the optical property. The optical information storage element may further be adapted to be altered to a third state. For example, a first transition from the first state to the second state may be induced during the production of the optical information storage element, for example to store initial information, such as information relating to the identification or lot of the aerosol-generating article. A second transition from the second state to the third state may be induced during use of the aerosol-generating article, to store at least the information that the aerosol-generating article has been used.

In the first state, the segments may form a first optically readable code and in the second state, the segments may form a second optically readable code, wherein the first optically readable code and the second optically readable code each encode different information content. The first optically readable code may correspond to the optical information storage element with one or more segments in an un-altered condition. The second optically readable code may correspond to the optical information storage element with one or more segments in an altered condition. The optical information storage element may comprise more than one alterable segment. To alter the stored information, one, a plurality or all of the alterable segments may be altered. Individual alterable segments or groups of alterable segments may be altered based on different physical conditions, respectively, for example based on different temperature thresholds or radiation with different wavelengths. The first code and second code may be encoded and decoded according to a common principle, in particular based on a common algorithm. Accordingly, a detector adapted to read and decode the optical information storage element in a first state may also be adapted to read and decode the optical information storage element in a second state.

Each information content may have information of more than 1 bit. Accordingly, the optical information storage element may not only contain a Boolean yes-or-no information, for example concerning its usage, but may also contain information regarding at least one of the type production or use of the aerosol-generating article. Such information may comprise which temperature occurred during use, or when the aerosol-generating article was used. As un-alterable information, the optical information storage element may contain information regarding a best before date.

At least one optical property of the at least one alterable segment may uniformly differ in between the first state and the second state. The segment may define the spatially smallest changeable unit. An optical detector of the aerosol-generating device may be programmed to identify alterations and the size of these alterations. An optical detector may be programmed to identify alterations in the size of the segment. Thus, it may be possible to filter alterations having a smaller or bigger spatial extension as one alterable segment.

The at least one alterable segment may be an optically distinguishable shape. The segment may have side lengths smaller than 2 millimeter, smaller than 1 millimeter, smaller than 500 micrometer, or smaller than 200 milcrometer, and in particular greater than 100 milcrometer. The segment may have side lengths greater than 100 milcrometer, greater than 200 milcrometer, greater than 500 micrometer, or greater than 1 millimeter, and in particular smaller than 2 millimeter. The segment may be a rectangle with sides of different length or may be quadratic. An optical detector of the aerosol-generating device may be programmed to identify changes in the optical information storage element storing information, by comparing the data of an earlier detection with a later detection. An optical detector or a control unit of the aerosol-generating device may be programmed to identify a segment in the optical information storage element, by specifying a reference frame for the optical information storage element, and then analysing the detected properties of several or all segments. The optical detector or control unit may compare the data of a detection with data stored in a database, wherein the stored data comprises at least one of size, shape or position of one or more segments in an optical information storage element.

The at least one alterable segment may comprise three or more layers, wherein at least one optical property of at least one layer of the three or more layers is adapted to be altered. This may facilitate a higher information density due to a higher number of combinations of optical properties of the three or more layers. At least one different optical properties may be altered in one layer compared to another layer. The alterable optical properties may be one or more of color, transparency, hue, saturation, or lightness. For example, a lower layer may have a changeable color, the middle layer may be alterable from transparent to a certain color, which is different from the colors of the first layer, and the upper layer may be alterable from transparent to opaque or even a further color. The ambient conditions, which induce the respective changes may be different for the individual layers.

The first layer may comprise at least one material different to one or more materials of the second layer. Thus, information may be stored based on the combination of these two different materials. In particular, information may be stored based on different optical properties of these two materials. For example, the first material may have a certain color, wherein the second material may be transparent. The different materials may be alterable differently. For example, the first material may be alterable from a first to a second color and the second material may be alterable from transparent to opaque, or non-alterable. The physical conditions, which induce the respective changes may be different for the individual materials.

Two or more different materials may be disposed in the first layer or the second layer or both. Thus, information may be stored based on the spatial arrangement of the materials, wherein the different materials comprise different optical properties. For example, information may be stored by the spatial arrangement of segments having different colors. The different materials may be alterable differently. For example, the first material may be alterable from a first to a second color and the second material may be alterable from transparent to opaque, or non-alterable. The physical conditions, which induce the respective changes may be different for the individual materials.

A material of the second layer may overlay a different material of the first layer. For example, the material of the first layer may comprise a certain color and the material of the second layer may be transparent and alterable to opaque. Accordingly, information may be stored based on the color of a segment and the visibility of the color.

The optical property may be a color. The optical property may be black or white. The optical property may be transparency. The optical property may be reflection. The optical property may be brightness. The optical properties may be used to store information in the optical information storage element. Accordingly, the optical properties may be regarded as to provide a further multi-dimensionality, additionally to a spatial distribution of the segments.

The optical property may be irreversibly alterable. For example, a temperature at and above a certain temperature threshold may irreversibly alter the optical property of a material and may therefore indicate if the aerosol-generating article has been used.

The optical property may be reversibly alterable. For example, a time-controlled usage of an aerosol-generating article may be realized. For example, an optical detector, respectively a control unit of the aerosol-generating device may be programmed to allow a further use of the aerosol-generating article after a segment in the optical information storage element has reverted back to its initial state. Otherwise, the use may be prevented by deactivation of the device or heater. A material in the optical information storage element may change its color by thermal activation or irradiation and may change back to its initial color after a certain amount of time. In particular, the material may change back to its initial state only after more than 10 minutes. In particular, the material may change back to its initial state only after more than one hour. The alterations of the optical information storage element may be based on changes of different optical properties of different materials or may be based on changes of optical properties of different materials under different conditions or both.

The optical property may be alterable by exposure to a temperature exceeding a temperature threshold, preferably a temperature threshold of 60 degrees Celsius. Accordingly, a temperature which may occur at the place of the optical information storage element during heating of the aerosol-generating substrate may induce an alteration of the optical properties.

The optical property may be alterable by exposure to a radiation, preferably by electromagnetic radiation. The electromagnetic radiation may be infrared, visible or ultraviolet light. The radiation may be applied during the production or during use of the aerosol-generating article or both.

The optical property may be time dependently alterable. In particular, the change of the material may depend on the time exposed to a certain condition, for example a certain temperature or an electromagnetic radiation.

The optical information storage element may comprise a two-dimensional code. In particular, the segments may be arranged next to each other in a width direction and a length direction. Thus, a higher information density may be provided on an available space as compared to a one-dimensional code.

The optical information storage element may comprise a matrix code. This may facilitate a higher information density as for example compared to a stacked barcode, namely several barcodes arranged next to each other.

The aerosol-generating article may comprise two or more optical information storage elements. Thus, there is a higher probability that at least one optical information storage element is within a field of view of a detector as compared to the case when only one optical information storage elements is present on the aerosol-generating article. Accordingly, if the detector is arranged in or at an aerosol-generating device, for example in a cavity of the aerosol-generating device, the aerosol-generating article may not need to be inserted in a specific circumferential orientation. Preferably, a plurality of optical information storage elements is present on the aerosol-generating article. More preferably, a plurality of optical information storage elements is present around the circumference of the aerosol-generating article or along the longitudinal direction of the aerosol-generating article. The optical information storage elements may be aligned with each other. The one or more information storage element may be positioned near a mouthpiece section of the aerosol-generating article, or may be positioned near a distal end opposite to the mouthpiece.

Two or more optical information storage elements may be spaced apart from each other. If more than one optical information storage element is present in the field of view of a detector, the detector may distinguish the single elements by detecting boundaries or empty spaces between the optical information storage elements or both.

The optical information storage element may comprise a marker or recognition pattern in order to be detectable as single unit. For example, two or more corners of a quadratic optical information storage element may comprise a specific pattern.

The aerosol-generating article may be a “heat not burn” article in which aerosol-generating substrate is heated to release aerosol but not burned. The aerosol-generating substrate may comprise tobacco material. The tobacco material may comprise one or more of: powder, granules, pellets, shreds, spaghettis, strips or sheets containing one or more of: tobacco leaf, fragments of tobacco ribs, reconstituted tobacco, homogenised tobacco, extruded tobacco and expanded tobacco. Optionally, the tobacco material may contain additional tobacco or non-tobacco volatile flavour compounds, to be released upon heating of the tobacco material. Optionally, the tobacco material may also contain capsules that, for example, include the additional tobacco or non-tobacco volatile flavour compounds. Such capsules may melt during heating of the tobacco material. Alternatively, or in addition, such capsules may be crushed prior to, during, or after heating of the tobacco material.

Where the tobacco material comprises homogenised tobacco material, the homogenised tobacco material may be formed by agglomerating particulate tobacco. The homogenised tobacco material may be in the form of a sheet. The homogenised tobacco material may have an aerosol-former content of greater than 5 percent on a dry weight basis. The homogenised tobacco material may alternatively have an aerosol former content of between 5 percent and 30 percent by weight on a dry weight basis. Sheets of homogenised tobacco material may be formed by agglomerating particulate tobacco obtained by grinding or otherwise comminuting one or both of tobacco leaf lamina and tobacco leaf stems; alternatively, or in addition, sheets of homogenised tobacco material may comprise one or more of tobacco dust, tobacco fines and other particulate tobacco by-products formed during, for example, the treating, handling and shipping of tobacco. Sheets of homogenised tobacco material may comprise one or more intrinsic binders, that is tobacco endogenous binders, one or more extrinsic binders, that is tobacco exogenous binders, or a combination thereof to help agglomerate the particulate tobacco. Alternatively, or in addition, sheets of homogenised tobacco material may comprise other additives including, but not limited to, tobacco and non-tobacco fibres, aerosol-formers, humectants, plasticisers, flavourants, fillers, aqueous and non-aqueous solvents and combinations thereof. Sheets of homogenised tobacco material are preferably formed by a casting process of the type generally comprising casting a slurry comprising particulate tobacco and one or more binders onto a conveyor belt or other support surface, drying the cast slurry to form a sheet of homogenised tobacco material and removing the sheet of homogenised tobacco material from the support surface.

According to a second aspect of the present invention, there is provided a method for manufacturing an information storage element, in particular for an aerosol-generating article. The method comprises the steps of depositing a first material layer on a surface, depositing a second material layer at least partly on the first material layer, wherein the first material layer is formed in a first pattern and the second material layer is formed in a second pattern, wherein the second pattern at least partially corresponds to the first pattern. Accordingly, a three-dimensional information storage element may be formed, having an information content based on the characteristics of the individual layers and their spatial extent.

The second layer may be alterable in its physical properties, in particular regarding one or more of its inductivity, capacity, magnetization, color, transparency, hue, saturation, or lightness. For example, the transparency of the second layer may be altered from transparent to opaque. Accordingly, the one or more colors of the underlying first layer may be visible or not visible.

The second layer may be formed in a grid pattern with a plurality of segments comprising at least one alterable segment. Accordingly, information may be stored in the information storage element based on the optical properties of the segments. Information may be stored based on the spatial arrangement of the segments.

The first layer may be formed in a first pattern while depositing the first layer. Accordingly, an additional process step for forming the first pattern may be omitted.

The second layer may be formed in a second pattern while depositing the second layer. Accordingly, an additional process step for forming the second pattern may be omitted. The depositing may be done by printing. The printing may be effected by a print head comprising a plurality of nozzles. The print head may be digitally controlled. The print head may be configured to spray material. The print head may be configured to selectively spray series of different material or different print heads may be provided to spray different material for the first layer and second layer.

The forming of the first layer or second layer or both may comprise to induce a physical or chemical material change. The material change may be temporary or permanent to store information. The material change may make the material processable, for example alter its viscosity or binding properties. Material changes may be induced depending on the specific material as used for the first layer and second layer or both.

A photorheological material may undergo a change in fluidity, viscosity and other rheological properties when exposed to a specific electromagnetic radiation, for example ultraviolet or infrared light. These materials changes are in particular beneficial for depositing the material.

A photochromic material may undergo a change in physical or chromatic properties or both when exposed to a specific electromagnetic radiation. Changeable properties are in particular transparency and color.

A photochemical material may undergo a change in its physical and chromatic properties based on chemical reactions. Chemical reactions with an adjacent material may be induced by electromagnetic radiation. The material change may be used for information storage and depositing the material.

A plasmonic material may undergo a reversible change in its physical or chromatic properties when exposed to a specific electromagnetic radiation or a specific temperature. In particular, an altering of the color may be induced.

A thermochromic or a thermoreactive material may undergo a reversible or irreversible change in its physical or chromatic properties when exposed to a specific temperature. In particular a color change or change in the surface characteristics may be induced by a specific temperature.

The materials used for the first layer or second layer or both may be ink-like materials, namely materials which are fluid in a first state and then cure to be solid in a second state. The material used for the first layer or second layer or both may comprise monomers, oligomers, pigments or photo-initiators or combinations thereof. The material may be cured or undergo a color change when exposed to ultraviolet light. The material may be Leuco-Dye based epoxy ink, which may undergo a color change induced by exposure to a certain temperature and will revert back to its original color after a certain amount of time. The material may comprise an isopropanol heterocyclic organic dye and may undergo an irreversible color-change when exposed to a certain temperature.

The material used for the first layer or second layer or both may undergo a material change at a temperature of 60 degrees Celsius and above. In particular, the material may undergo a material change at a temperature range between 60 degrees Celsius and 270 degrees Celsius. In particular, the material may undergo a material change at a temperature range between 60 degrees Celsius and 120 degrees Celsius.

Accordingly, the depositing of a first material or a second material may be performed under a condition, differing from ambient conditions. In particular, the depositing may be performed under application of an electromagnetic radiation in order to set a specific fluidity or viscosity of a material to be deposited. Further, the depositing may be performed under application of an electromagnetic radiation in order to store a specific information, in particular to encode a specific information by material properties, for example color.

The material change may be reversible.

The material change may be irreversible. In particular, the material change may be an interaction of one material with another material in direct contact. Such material change may be in particular a chemical interaction of two different materials.

The forming of the first layer or second layer or both may comprise etching. Etching may in particular be used to perform an irreversible material change.

The forming of the first layer or second layer or both may comprise irradiation with an electromagnetic radiation. Etching may be radiation-based etching.

The forming of the first layer or second layer or both may comprise irradiation with an electromagnetic radiation of a wavelength between 100 nanometers and 1000 nanometers. The wavelength may be selected depending on the wavelength at which a material change of a specific material occurs.

The forming of the first layer or second layer or both may comprise irradiation with an electromagnetic radiation of a wavelength between 100 nanometers and 400 nanometers. This range of wavelength corresponds to ultraviolet light

The forming of the first layer or second layer or both may comprise irradiation with an electromagnetic radiation of a wavelength between 400 nanometers and 800 nanometers. This range of wavelength corresponds to light, visible for the human eye.

The forming of the first layer or second layer or both may comprise irradiation with an electromagnetic radiation of a wavelength between 800 nanometers and 1000 nanometers. This range of wavelength corresponds infrared radiation.

The forming of the first layer or second layer or both may comprise thermal exposure.

The forming of the first layer or second layer or both may comprise magnetization. Thus, information may be stored based on a pattern of differently magnetized segments.

The step of depositing a first layer or the step of depositing a second layer or both may comprise a digital printing method. Accordingly, ink-like materials may be processed.

The step of depositing a first layer or the step of depositing a second layer or both may comprise an additive manufacturing method.

The step of depositing a first layer or the step of depositing a second layer or both may comprise one of ink jet printing, selective laser sintering, sheet lamination, material jetting.

The method may further comprise the step of making material processable by inducing a physical or chemical material change before or during depositing the first material layer or second material layer. For example, the viscosity of a material may be changed to become fluid in order to print the material like an ink. After depositing the material, the material may return to its default state, for example become solid again. The material of the first layer or second layer or both may be processable only under physical conditions differing from the ambient conditions, for example at an elevated temperature or under application of electromagnetic radiation. Preferably, a temperature for processing a material may be higher than the normal ambient temperature during storage or use of the aerosol-generating article.

The step of making material processable may comprise inducing a change in at least one of viscosity, fluidity, transparency and coloring. The material change may also influence the binding characteristics of the material.

According to a third aspect of the present invention, there is provided an aerosol-generating system comprising an aerosol-generating article and an aerosol-generating device. The aerosol-generating article is adapted to be heated in the aerosol-generating device. The aerosol-generating article comprises an information storage element with at least two layers, wherein the information storage element is alterable from a first state to a second state by altering at least one layer of the information storage element. The aerosol-generating device is adapted to read the information storage element in the first state and in the second state. The information storage element may contain information on a manufacturer, a manufacturing site, a manufacturing time, a best-before date or a product type. Accordingly, based on this information, the system may be adapted to authenticate the aerosol-generating article. The consumption of non-authenticated articles may accordingly be disabled. Based on the identified product type, the operating mode of the aerosol-generating device may be set. In particular, a specific operating mode may be set for each of a heated tobacco product (HTP), a nicotine containing product (NCP) including a vaping system, a hybrid of heated tobacco and nicotine containing product, herbals, or a combination thereof. Accordingly, an aerosol-generating device may be used with different types of aerosol-generating article.

The aerosol-generating device may be adapted to read out more than one bit of information both in the first state and in the second state. The information storage element may provide its alterable information readable and decodable in the same way for both the first and the second state. Thus, the information storage element is readable by the aerosol-generating device in both the first and the second state.

The information storage element may comprise a grid pattern with a plurality of segments comprising at least one alterable segment. A grid pattern may be beneficial for a standardized recognition algorithm performed by a data processing unit wired or wirelessly connected to a detector in the aerosol-generating device. In particular, the possible alterations of segments may be predetermined depending on physical conditions to which the information storage element is subjected. The total area of an alterable segment may switch from black to white or from transparent to opaque or from one color to another. Information may be stored in a grid pattern based on a specific encoding. The encoding may be cryptographically signed or encrypted or both. Accordingly, counterfeiting or accessing the information in the information storage element may be prevented.

The aerosol-generating device may comprise a detector adapted to read out the information storage element with at least one segment in an altered condition. The detector may be disposed within the aerosol-generating device such, that the information storage element is positioned in the field of view of the detector, when the aerosol-generating article is inserted in a receiving cavity of the aerosol-generating device. In particular, the detector may face the inside of the cavity of the aerosol-generating device adapted to receive the aerosol-generating article.

The detector may be adapted to detect at least one of a magnetic field and an electromagnetic radiation. The detector may be an RGB-sensor, capable of detecting ranges of electromagnetic radiation including red, green and blue. The detector may be a CCD-sensor (charge-coupled device sensor). The detector may include optical components, for example one or more of a lense, filter, coating, or polarized optics. The detector may have dimensions suitable to be disposed in an aerosol-generating device. In particular, the detector may have a maximum side length of 1.2 millimeters.

The aerosol-generating device is adapted to alter the information storage element from the first state to the second state by altering at least one layer of the information storage element. Thus, the aerosol-generating article may be marked as used and disabled from a second use. The aerosol-generating device may also be adapted to alter the information storage element in order to store the information when the aerosol-generating article was used, how long or at which temperature.

The aerosol-generating device may comprise a radiation source. In particular, the radiation source may emit electromagnetic radiation. The electromagnetic radiation emitted by the radiation source may be electromagnetic waves having a wavelength in the range of 100 nanometers to 1000 nanometers. The radiation source may be a LED (light-emitting diode), OLED (organic light-emitting diode), QLED (quantum-dot light-emitting diode). The one or more materials used in the information storage element may respond to the electromagnetic radiation by reflection of one or more wavelengths. The one or more materials used in the information storage element may be shifted to an excited state by the electromagnetic radiation emitted of the radiation source and may emit an electromagnetic radiation by leaving the excited state. The excited state may be a fluorescent or phosphorescent state. The radiation source may be configured to emit a selectable electromagnetic radiation.

The aerosol-generating device may comprise a magnet for altering the information storage element. The magnet may be an electromagnet. The electromagnet may be adapted to alter and read the information of the information storage element. The magnet may be a ferromagnet. The aerosol-generating device may comprise a plurality of magnets, for example an electromagnetic write-head, an electromagnetic read-and-write-head or a ferromagnetic write-head.

The aerosol-generating device may be adapted to altering the information storage element by applying heat to the information storage element. The heat may be generated with the device, which is also used for heating the aerosol-generating substrate in order to generate aerosol. Alternatively, the heat may be generated with an additional heating means in the aerosol-generating device. The information storage element may be located on the aerosol-generating article, such that when inserted into the aerosol-generating device, the information storage element is located near an electrical resistance heating element. Alternatively, the aerosol-generating article may comprise a heating element that produces heat through magnetic induction and the heat dissipated to the location of the information storage element on the aerosol-generating article may alter the information storage element. As another alternative, the heating element may be inserted into the aerosol-generating article when the aerosol-generating article is inserted into the aerosol-generating device. The temperature created at the location of the information storage element may be in the range of 60 degrees Celsius and above. In particular, the temperature created at the location of the information storage element may be in the range between 60 degrees Celsius and 270 degrees Celsius. In particular, the temperature created at the location of the information storage element may be in the range between 60 degrees Celsius and 120 degrees Celsius.

The electronic components of the aerosol-generating system, in particular the detector and an excitation source may be connected to a control unit. The control unit may be arranged in the aerosol-generating device. The control unit may comprise a data processing unit, a data storage unit and a data exchange interface. The data exchange interface may be configured to establish a connection with a network, and in particular establish a connection with an external data processing device, for example a server. The data exchange interface may be configured to establish a connection with an external data processing device via wireless communication, for example WLAN, Bluetooth or cellular communication protocols. The control unit may be connected with other electronic components of the aerosol-generating device, in particular with a heating element. The control unit may be configured to control the functionality of the aerosol-generating device depending on the information read from the information storage element of the aerosol-generating article. In particular, the control unit may control the functionality of a heating element based on the information read from the information storage element.

According to a fourth aspect of the present invention there is provided a use of a multi-layered information storage element on an aerosol-generating article to provide alterable supplemental information about the aerosol-generating article, wherein at least one layer comprises a plurality of segments comprising at least one alterable segment. The multi-layered information storage element may provide a higher information density as compared to a single-layered structure. Further, the information stored in the information storage element may be altered by altering one layer of the at least one segment.

The aerosol-generating article according to the first aspect of the invention may be manufactured by the method according to the second aspect of the invention.

The use of a multi-layered information storage element according to a fourth aspect of the invention may be performed with the article according to the first aspect of the invention in any of its embodiments or the system according to the third aspect of the invention.

The invention is defined in the claims. However, below there is provided a non-exhaustive list of non-limiting examples. Any one or more of the features of these examples may be combined with any one or more features of another example, embodiment, or aspect described herein.

Example Ex1: Aerosol-generating article, adapted to be electrically heated by an aerosol-generating device, the aerosol-generating article comprising an aerosol-generating substrate, an optical information storage element storing information in a grid pattern with a plurality of segments comprising at least one alterable segment, wherein the at least one alterable segment comprises a first layer and a second layer, wherein at least one optical property of at least one layer is adapted to be altered.

Example Ex2: Aerosol-generating article according to Example Ex1, wherein the segments are rectangular segments.

Example Ex3: Aerosol-generating article according to any one of Examples Ex1 to Ex2, wherein the optical information storage element is adapted to be altered from a first state to a second state, wherein at least one optical property of the at least one alterable segment differs in between the first state and the second state.

Example Ex4: Aerosol-generating article, according to Example Ex3, wherein in the first state the segments form a first optically readable code and wherein in the second state the segments form a second optically readable code, wherein the first optically readable code and the second optically readable code each encode different information content.

Example Ex5: Aerosol-generating article according to any one of Examples Ex1 to Ex4, wherein each information content has information of more than 1 bit.

Example Ex6: Aerosol-generating article according to any one of Examples Ex3 to Ex5, wherein at least one optical property of the at least one alterable segment uniformly differs in between the first state and the second state.

Example Ex7: Aerosol-generating article according to any one of Examples Ex1 to Ex6, wherein the at least one alterable segment is optically distinguishable.

Example Ex8: Aerosol-generating article according to any one of Examples Ex1 to Ex7, wherein the at least one alterable segment comprises three or more layers, wherein at least one optical property of at least one layer of the three or more layers is adapted to be altered.

Example Ex9: Aerosol-generating article, according to any one of Examples Ex1 to Ex8, wherein the first layer comprises at least one material different to one or more materials of the second layer.

Example Ex10: Aerosol-generating article, according to any one of Examples Ex1 to Ex9, wherein two or more different materials are disposed in the first layer and/or the second layer.

Example Ex11: Aerosol-generating article, according to any one of Examples Ex1 to Ex10, wherein a material of the second layer overlays a different material of the first layer.

Example Ex12: Aerosol-generating article, according to any one of Examples Ex1 to Ex11, wherein the optical property is a color.

Example Ex13: Aerosol-generating article, according to any one of Examples Ex1 to Ex12, wherein the optical property is black or white.

Example Ex14: Aerosol-generating article, according to any one of Examples Ex1 to Ex13, wherein the optical property is transparency.

Example Ex15: Aerosol-generating article, according to any one of Examples Ex1 to Ex14, wherein the optical property is reflection.

Example Ex16: Aerosol-generating article, according to any one of Examples Ex1 to Ex15, wherein the optical property is brightness.

Example Ex17: Aerosol-generating article, according to any one of Examples Ex1 to Ex16, wherein the optical property is irreversibly alterable.

Example Ex18: Aerosol-generating article, according to any one of Examples Ex1 to Ex17, wherein the optical property is reversibly alterable.

Example Ex19: Aerosol-generating article, according to any one of Examples Ex1 to Ex18, wherein the optical property is alterable by exposure to a temperature exceeding a temperature threshold, preferably a temperature threshold of 60 degrees Celsius.

Example Ex20: Aerosol-generating article, according to any one of Examples Ex1 to Ex19, wherein the optical property is alterable by exposure to a radiation, preferably by electromagnetic radiation.

Example Ex21: Aerosol-generating article, according to any one of Examples Ex1 to Ex20, wherein the optical information storage element comprises a two-dimensional code.

Example Ex22: Aerosol-generating article, according to any one of Examples Ex1 to Ex21, wherein the optical information storage element comprises a matrix code.

Example Ex23: Aerosol-generating article, according to any one of Examples Ex1 to Ex22, comprising two or more optical information storage elements.

Example Ex24: Aerosol-generating article, according to any one of Examples Ex1 to Ex23, comprising two or more optical information storage elements being spaced apart from each other.

Example Ex25: Aerosol-generating article, according to any one of Examples Ex1 to Ex24, wherein the optical information storage element comprises a recognition pattern in order to be identifiable as single unit.

Example Ex26: Method for manufacturing an information storage element, in particular for an aerosol-generating article, the method comprising the steps of:
depositing a first material layer on a surface,
depositing a second material layer at least partly on the first material layer,
wherein the first material layer is formed in a first pattern, and
the second material layer is formed in a second pattern,
wherein the second pattern at least partially corresponds to the first pattern.

Example Ex27: Method according to Example Ex26, wherein the second layer is alterable.

Example Ex28: Method according to any one of Examples Ex26 to Ex27, wherein the second layer is formed in a grid pattern with a plurality of rectangular segments comprising at least one alterable segment.

Example Ex29: Method according to any one of Examples Ex26 to Ex28, wherein the first layer is formed in a first pattern while depositing the first layer.

Example Ex30: Method according to any one of Examples Ex26 to Ex29, wherein the second layer is formed in a second pattern while depositing the second layer.

Example Ex31: Method according to any one of Examples Ex26 to Ex30, wherein the forming comprises to induce a physical or chemical material change.

Example Ex32: Method according to any one of Examples Ex26 to Ex31, wherein the material change is reversible.

Example Ex33: Method according to any one of Examples Ex26 to Ex32, wherein the material change is irreversible.

Example Ex34: Method according to any one of Examples Ex26 to Ex33, wherein the forming comprises etching.

Example Ex35: Method according to any one of Examples Ex26 to Ex34, wherein the forming comprises irradiation with an electromagnetic radiation.

Example Ex36: Method according to any one of Examples Ex26 to Ex35, wherein the forming comprises irradiation with an electromagnetic radiation of a wavelength between 100 nanometers and 1000 nanometers.

Example Ex37: Method according to any one of Examples Ex26 to Ex36, wherein the forming comprises irradiation with an electromagnetic radiation of a wavelength between 100 nanometers and 400 nanometers.

Example Ex38: Method according to any one of Examples Ex26 to Ex37, wherein the forming comprises irradiation with an electromagnetic radiation of a wavelength between 400 nanometers and 800 nanometers.

Example Ex39: Method according to any one of Examples Ex26 to Ex38, wherein the forming comprises irradiation with an electromagnetic radiation of a wavelength between 800 nanometers and 1000 nanometers.

Example Ex40: Method according to any one of Examples Ex26 to Ex39, wherein the forming comprises thermal exposure.

Example Ex41: Method according to any one of Examples Ex26 to Ex40, wherein the forming comprises magnetization.

Example Ex42: Method according to any one of Examples Ex26 to Ex41, wherein the step of depositing a first and/or second layer comprises a digital printing method

Example Ex43: Method according to any one of Examples Ex26 to Ex42, wherein the step of depositing a first and/or second layer comprises an additive manufacturing method.

Example Ex44: Method according to any one of Examples Ex26 to Ex43, wherein the step of depositing a first and/or second layer comprises one of ink jet printing, selective laser sintering, sheet lamination, material jetting.

Example Ex45: Method according to any one of Examples Ex26 to Ex44, wherein the method further comprises the step of making material processable by inducing a physical or chemical material change before or during depositing the first material layer or second material layer.

Example Ex46: Method according to Example Ex45, wherein the step of making material processable comprises inducing a change in at least one of viscosity, fluidity, transparency and coloring.

Example Ex47: Aerosol-generating system comprising an aerosol-generating article and an aerosol-generating device, the aerosol-generating article being adapted to be heated in the aerosol-generating device, wherein the aerosol-generating article comprises an information storage element with at least two layers, wherein the information storage element is alterable from a first state to a second state by altering at least one layer of the information storage element, wherein the aerosol-generating device is adapted to read the information storage element in the first state and in the second state.

Example Ex48: Aerosol-generating system according Example Ex47, wherein the aerosol-generating device is adapted to read out more than 1 bit of information both in the first state and in the second state.

Example Ex49: Aerosol-generating system according to any one of Examples Ex47 to Ex48, wherein the information storage element comprises a grid pattern with a plurality of segments comprising at least one alterable segment.

Example Ex50: Aerosol-generating system according to any one of Examples Ex47 to Ex49, wherein the aerosol-generating device comprises a detector adapted to read out the information storage element with at least one segment in an altered condition.

Example Ex51: Aerosol-generating system according Example Ex50, wherein the detector is adapted to detect at least one of a magnetic field and an electromagnetic radiation.

Example Ex52: Aerosol-generating system according to any one of Examples Ex47 to Ex51, wherein the aerosol-generating device is adapted to alter the information storage element from the first state to the second state by altering at least one layer of the information storage element.

Example Ex53: Aerosol-generating system according to any one of Examples Ex47 to Ex52, wherein the aerosol-generating device comprises a magnet for altering the information storage element.

Example Ex54: Aerosol-generating system according to any one of Examples Ex47 to Ex53, wherein the aerosol-generating device is adapted to altering the information storage element by applying heat to the information storage element.

Example Ex55: Use of a multi-layered information storage element on an aerosol-generating article to provide alterable supplemental information about the aerosol-generating article, wherein at least one layer comprises a plurality of segments comprising at least one alterable segment.

Examples will now be further described with reference to the figures.

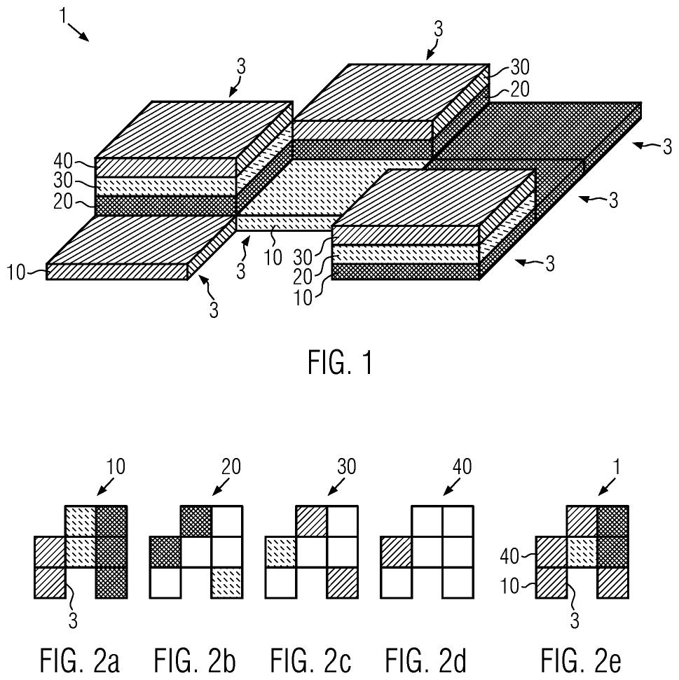

FIG. 1 shows a perspective view of a four-layered information storage element.

FIG. 2 a-e show a top view of the four single layers of the information storage element of FIG. 1 and a top view of the information storage element as a whole.

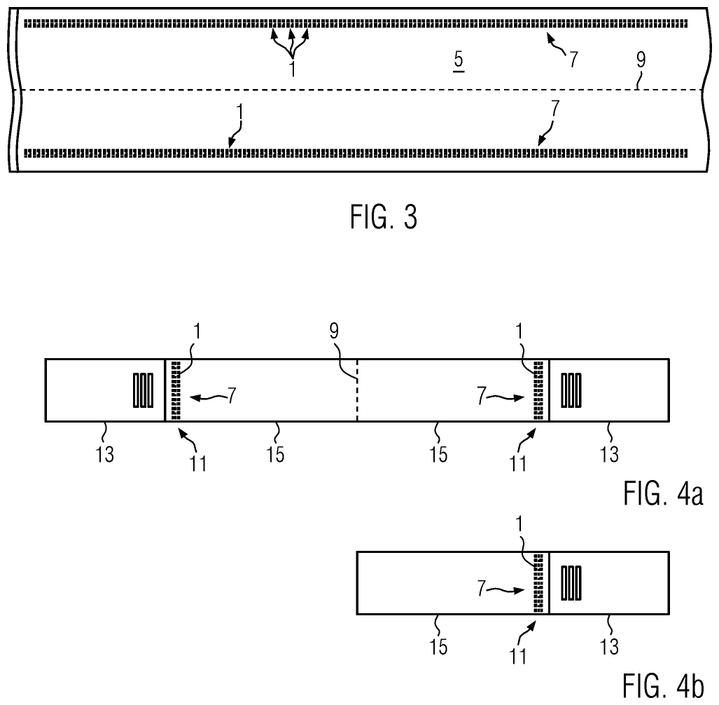

FIG. 3 shows a substrate material comprising two strips of a plurality of information storage elements.

FIG. 4a shows two aerosol-generating articles, each comprising a strip of a plurality of information storage elements.

FIG. 4b shows one aerosol-generating article comprising a strip of a plurality of information storage elements.

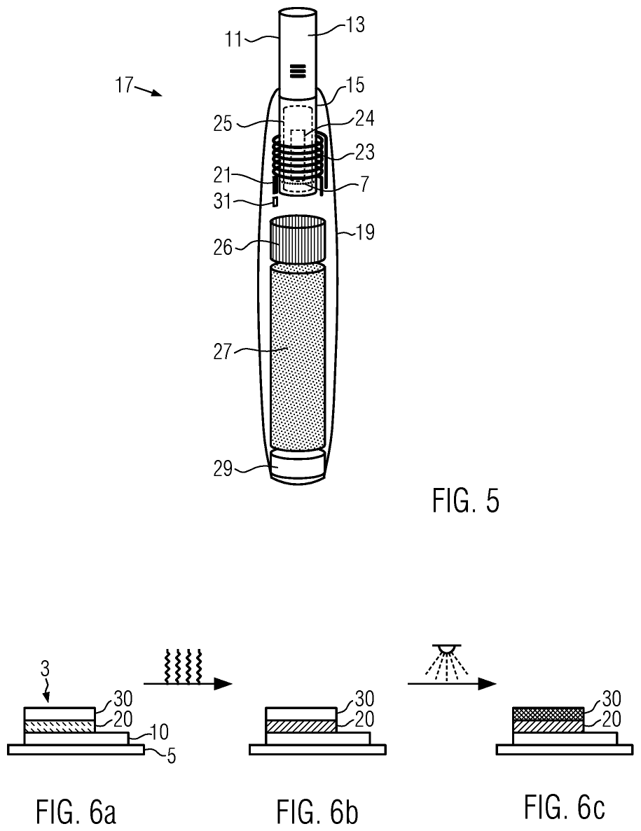

FIG. 5 shows an aerosol-generating system, comprising an aerosol-generating article inserted into an aerosol-generating device.

FIG. 6 a-c show a sectional view of a segment undergoing two material changes.

FIG. 1 shows a perspective view of an information storage element 1. Seven segments 3 are arranged in a grid pattern. The segments 3 have a quadratic shape. The segments 3 comprise varying numbers of layers 10, 20, 30, 40 and may thus comprise only one single layer 10 or may comprise a structure of several layers 10, 20, 30, 40. Each layer 10, 20, 30, 40 of a segment 3 may be made of a different material, as indicated by different hatching patterns in FIGS. 1 and 2. Each layer 10, 20, 30, 40, that means each level, may also have different materials for different segments 3. As shown in this example, the information storage element 1 may have any outer shape and does not need to be a regular rectangle or quadrat at its outer boundaries. However, the outer shape may represent a recognition pattern that helps to identify a valid information storage element 1 by a recognition program of a control unit.

FIG. 2a shows the first layer 10, which is the lowest layer of the information storage element 1. Each square represents the first or lowest layer 10 of one segment 3. FIG. 2b shows the second layer 20, FIG. 2c shows the third layer 30 and FIG. 2d shows the fourth layer 40 or most upper layer of the information storage element 1. Squares filled with a hatching pattern represent a specific material present at the current level of the respective segment 3. Unfilled squares indicate, that no material layer is present for the respective segment 3 at this level or layer 10, 20, 30, 40. FIG. 2e shows a top view of the information storage element 1 as a whole. Accordingly, each square represents the topmost visible layer 10, 20, 30, 40 of one segment 3. For example, in the most left row, for one segment 3 is the layer 10 the visible topmost layer and for the other segment 3 is the layer 40 the topmost visible layer. The different materials, as indicated by the hatching patterns, may have different properties, in particular different optical properties. These properties may be altered under certain conditions, for example under exposure to a certain temperature or to an electromagnetic radiation. For example, a material of the layer 40 may be altered from black or opaque to transparent. Accordingly, the material of an underlying layer 30, which may have a different color, for example red, may become visible. Accordingly, the segment 3 switches from black to red, what represents a change in the stored information, which is detectable by a suitable detector.

FIG. 3 shows a carrier surface 5, for example a wrapper for an aerosol-generating article, in particular for enveloping an aerosol-generating substrate core. The surface 5 comprises two strips 7 of a plurality of information storage elements 1. The surface 5 can be manufactured as an endless tape in a first step and be cut into appropriate pieces in a subsequent step. In the middle of the surface 5 a separation line 9 is indicated, where the surface 5 can be cut into a first and a second part in order to produce wrappers for two aerosol-generating articles facing each other at their distal ends as shown in FIG. 4a.

FIG. 4a shows two aerosol-generating articles 11 comprising a mouthpiece 13 and a substrate part 15. The mouthpiece 13 may comprise a filter material and the substrate part 15 may comprise a core of aerosol-generating substrate that is enveloped by the wrapper or carrier surface 5. Each aerosol-generating article 11 comprises a strip 7 of a plurality of information storage elements 1 at its substrate part 15 in proximity to the mouthpiece 13. The two aerosol-generating articles 11 are each wrapped with a half of the carrier surface 5, as shown in FIG. 3 in a 90 degrees rotated orientation. The two aerosol-generating articles 11 will be cut at the separation line 9 in order to obtain single aerosol-generating articles 11 as shown in FIG. 4b.

FIG. 4b shows one aerosol-generating article 11 comprising a strip 7 of a plurality of information storage elements 1. The strip 7 extends around a complete circumferential line of the aerosol-generating article 11. Accordingly, when inserted into an aerosol-generating device, it is ensured that at least one information storage element 1 is optically detectable by a detector. In order to be distinguishable from each other, the information storage elements 1 are separated by a space and additionally comprise a pattern, for example specific corner elements, that can be recognized by a corresponding image recognition software in order to be identified as separate information storage elements 1.

FIG. 5 shows an aerosol-generating system 17, comprising an aerosol-generating article 11 inserted into an aerosol-generating device 19. In that example the strip 7 of information storage elements 1 is disposed at a distal end of the aerosol-generating article 11, opposite to the mouthpiece 13. A detector 21 is arranged in the aerosol-generating device 19 in proximity to the strip 7 of information storage elements 1. A stop (not shown) in the aerosol-generating device 19 ensures that the aerosol-generating article 11 is always inserted for a constant length in order that the strip 7 is in the field of view of the detector 21. An induction coil 23 is provided in the aerosol-generating device 19 to inductively heat a susceptor 24 within an aerosol-generating substrate 25 of the aerosol-generating article 11. Alternatively, a heating blade of the device may be heated by electrical resistance heating while being inserted in the substrate.

The aerosol-generating device 19 further comprises a control unit 26, a power supply 27, for example a battery, and a power charging and data port 29. An excitation source 31 is disposed in the aerosol-generating device 19, which excites one or more of the segments 3 of the information storage element 1, or emits radiation, which is reflected by the information storage element 1. The excitation source 31 may be a source of electromagnetic radiation, for example a light emitting diode, or a magnet or the like. The aerosol-generating device 19 may further comprise an antenna, for example as part of the data port 29, in order to establish a wireless communication to an external data processing device. When the aerosol-generating article 11 is heated in the aerosol-generating article 11, at least one but preferably several segments 3 of the information storage element undergo a material change.

FIGS. 6a-c show a sectional view of a segment 3 undergoing two exemplary material changes. The segment 3 is disposed on the surface 5 and comprises a part of a common base layer or first layer 10, a second layer 20 and a third layer 30. In the first condition in FIG. 6a, the second layer 20 may have a specific color, for example red and the third layer 30 may be transparent. In a transition from the first condition in FIG. 6a to the second condition in FIG. 6b the information storage element 1 and in particular the segment 3 is exposed to a certain temperature, for example 90 degrees Celsius, which alters the color of the second layer 20, for example to yellow. In condition in FIG. 6b, the third layer 30 remains transparent. In a second transition to the third condition in FIG. 6c the information storage element 1 is exposed to ultraviolet light. This changes the third layer 30 from transparent to opaque. Accordingly, the second layer 20 is not visible anymore and the segment 3 may appear dark or black.

For the purpose of the present description and of the appended claims, except where otherwise indicated, all numbers expressing amounts, quantities, percentages, and so forth, are to be understood as being modified in all instances by the term “about”. Also, all ranges include the maximum and minimum points disclosed and include any intermediate ranges therein, which may or may not be specifically enumerated herein. In this context, therefore, a number A is understood as A±10% of A. Within this context, a number A may be considered to include numerical values that are within general standard error for the measurement of the property that the number A modifies. The number A, in some instances as used in the appended claims, may deviate by the percentages enumerated above provided that the amount by which A deviates does not materially affect the basic and novel characteristic(s) of the claimed invention. Also, all ranges include the maximum and minimum points disclosed and include any intermediate ranges therein, which may or may not be specifically enumerated herein.

1-15. (canceled)

16. Aerosol-generating article, adapted to be electrically heated by an aerosol-generating device, the aerosol-generating article comprising
an aerosol-generating substrate,
an optical information storage element storing information in a grid pattern with a plurality of segments comprising at least one alterable segment,
wherein the at least one alterable segment comprises a first layer and a second layer,
wherein at least one optical property of at least one layer is adapted to be altered,
wherein the second layer is at least partly deposited on the first layer and is formed in a grid pattern with a plurality of rectangular segments comprising at least one alterable segment.

17. Aerosol-generating article, according to claim 16, wherein the optical information storage element is adapted to be altered from a first state to a second state, wherein at least one optical property of the at least one alterable segment differs in between the first state and the second state.

18. Aerosol-generating article, according to claim 17, wherein in the first state the segments form a first optically readable code and wherein in the second state the segments form a second optically readable code, wherein the first optically readable code and the second optically readable code each encode different information content.

19. Aerosol-generating article, according to claim 17, wherein at least one optical property of the at least one alterable segment uniformly differs in between the first state and the second state.

20. Aerosol-generating article, according to claim 16, wherein the first layer comprises at least one material different to one or more materials of the second layer.

21. Aerosol-generating article, according to claim 16, wherein two or more different materials are disposed in the first layer and/or the second layer.

22. Aerosol-generating article, according to claim 16, wherein a material of the second layer overlays a different material of the first layer.

23. A method for manufacturing an information storage element, in particular for an aerosol-generating article, the method comprising the steps of:
depositing a first material layer on a surface,
depositing a second material layer at least partly on the first material layer,
wherein the first material layer is formed in a first pattern, and
the second material layer is formed in a second pattern,
wherein the second pattern at least partially corresponds to the first pattern and is formed in a grid pattern with a plurality of rectangular segments comprising at least one alterable segment.

24. Method according to claim 23, wherein the second layer is formed in a second pattern while depositing the second layer.

25. Method according to claim 23, wherein the forming comprises to induce a physical or chemical material change.

26. Method according to claim 23, wherein the forming comprises irradiation with an electromagnetic radiation.

27. Method according to claim 23, wherein the method further comprises the step of making material processable by inducing a physical or chemical material change before or during depositing the first material layer or second material layer.

28. Aerosol-generating system comprising an aerosol-generating article and an aerosol-generating device,
the aerosol-generating article being adapted to be heated in the aerosol-generating device,
wherein the aerosol-generating article comprises an information storage element with at least two layers, wherein the second layer is at least partly deposited on the first layer and is formed in a grid pattern with a plurality of rectangular segments comprising at least one alterable segment, wherein the information storage element is alterable from a first state to a second state by altering at least one layer of the information storage element,
wherein the aerosol-generating device is adapted to read the information storage element in the first state and in the second state.

29. Aerosol-generating system according to claim 28, wherein the aerosol-generating device is adapted to read out more than 1 bit of information both in the first state and in the second state.

30. Use of a multi-layered information storage element on an aerosol-generating article to provide alterable supplemental information about the aerosol-generating article, wherein a second layer is at least partly deposited on a first layer and is formed in a grid pattern with a plurality of rectangular segments comprising at least one alterable segment, wherein at least one layer comprises a plurality of segments comprising at least one alterable segment.
